(19) United States
(12) Patent Application Publication
(10) Pub. No.: US 2013/0342103 A1
(43) Pub. Date: Dec. 26, 2013

(54) SOLID STATE LIGHTING LUMINAIRE AND A FABRICATION METHOD THEREOF

(71) Applicants: Shing-Chung WANG, Hsinchu City (TW); Hao-Chung KUO, Hsinchu City (TW); Hsin-Chu CHEN, Hsinchu City (TW); Kuo-Ju CHEN, Hsinchu City (TW)

(72) Inventors: Shing-Chung WANG, Hsinchu City (TW); Hao-Chung KUO, Hsinchu City (TW); Hsin-Chu CHEN, Hsinchu City (TW); Kuo-Ju CHEN, Hsinchu City (TW)

(21) Appl. No.: 13/532,034

(22) Filed: Jun. 25, 2012

(51) Int. Cl. H01J 1/70; H01J 9/22

(52) U.S. Cl. 313/512; 445/58

(57) ABSTRACT

A solid state lighting luminaire, which comprises a solid state light source, an encapsulated structure, and a first phosphor, is provided. The encapsulated structure encapsulates the solid state light source and has an outside illuminating surface. The first phosphor is patterned to cover a portion of the outside illuminating surface for down-converting the illumination from the solid state light source.

### BACKGROUND OF THE INVENTION

1. Field of the Invention

This invention relates to a lighting luminaire, and particularly to a solid state lighting luminaire with remote phosphor.

2. Description of the Prior Art

Light emitting diodes (LEDs) are solid state lighting devices that convert electric energy to light, and generally comprise one or plural active layers of semiconductor material sandwiched between oppositely doped layers. When a bias voltage is applied across the doped layers, holes and electrons are injected into the active layer where they recombine to generate light.

To use an LED chip in lighting devices, it is known to enclose an LED chip in a package to provide environmental and mechanical protection, color selection, light focusing and the like. An LED package can also include electrical leads, contacts or traces for electrically connecting the LED package to an external power source. In a typical LED package 10 illustrated in FIG. 1, a single LED chip 12 is mounted on a cup reflector 14 by means of a solder bond or conductive epoxy, and the bonding wires 15 are used to connect the contacts of the LED chip 12 to traces (not shown). The reflective cup may be filled with an encapsulated structure 16 which may contain a wavelength conversion material such as a phosphor. The entire assembly may be further encapsulated in a clear protective resin, which may be molded in the shape of a lens to shape the light emitted from the LED chip, if needed.

LED packages 10 can generate white light by having a blue emitting LED chip 12 covered by a phosphor that absorbs blue light and re-emits yellow light. Some of the blue light passes through the conversion material without being converted such that the LED package 10 emits a white light combination of blue and yellow light.

Generally, the approach for forming the phosphor structure over the LED package utilized a typical two-step method. The first step is to dispense the transparent encapsulant filled up to certain portion of the package and then bake in a chamber to harden the encapsulant, so that the phosphor particles were kept in a certain distance from the blue LED chip. However, during the process, the outside surface of the encapsulant is generally a concave surface because of the capillary phenomena, which would cause the inhomogeneous phosphor thickness in the package. Since a longer excitation optical paths in larger angle may cause more down-conversion yellow rays, extra yellow light would be generated in the perimeter of the LED package to degrade lighting quality. This is understood as the yellow ring effect.

### SUMMARY OF THE INVENTION

it is an object of the present invention to provide a solid state lighting luminaire with remote phosphors to reduce the angular dependent CCT deviation as well as the yellow ring effect.

The present invention provide a solid state lighting luminaire, which comprises a solid state light source, an encapsulated structure, and a first phosphor. The encapsulated structure encapsulates the solid state light source and has an outside illuminating surface. The first phosphor is patterned to cover a portion of the outside illuminating surface for down-converting the illumination from the solid state light source.

A method of fabricating the above mentioned solid state lighting luminaire is provided in the present invention. The method comprises the steps of: a) providing a solid state light source; b) forming an encapsulated structure to encapsulate the solid state light source; and c) spraying a patterned first phosphor, which is utilized for down-converting the illumination from the solid state light source, on a predetermined portion of the outside illuminating surface.

### BRIEF DESCRIPTION OF THE DRAWINGS

FIG. 1 is a typical white light LED package with remote phosphor structure.

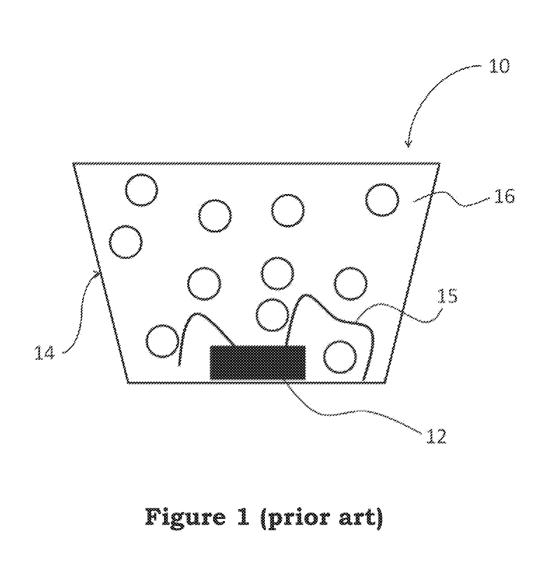

FIG. 2 is a schematic view of a white-light LED package in accordance with an embodiment of the present invention.

FIG. 3 is a diagram showing the experimental result of angular dependent CCT regarding the typical LED package with remote phosphor, the LED package with patterned phosphor as described in FIG. 2, and the typical LED package with phosphor mixed in the encapsulated structure.

FIG. 4 is a schematic view showing a fabrication method of the white-light LED package of FIG. 2 in accordance with an embodiment of the present invention.

FIG. 5 is a schematic view of a white-light LED package in accordance with another embodiment of the present invention.

FIG. 6 is a schematic view of a white-light LED package in accordance with still another embodiment of the present invention.

FIG. 7 is a schematic view showing a fabrication method of the white-light LED package of FIG. 5 in accordance with an embodiment of the present invention.

FIG. 8 is a schematic view showing a fabrication method of the white-light LED package of FIG. 6 in accordance with an embodiment of the present invention.

### DESCRIPTION OF THE PREFERRED EMBODIMENT

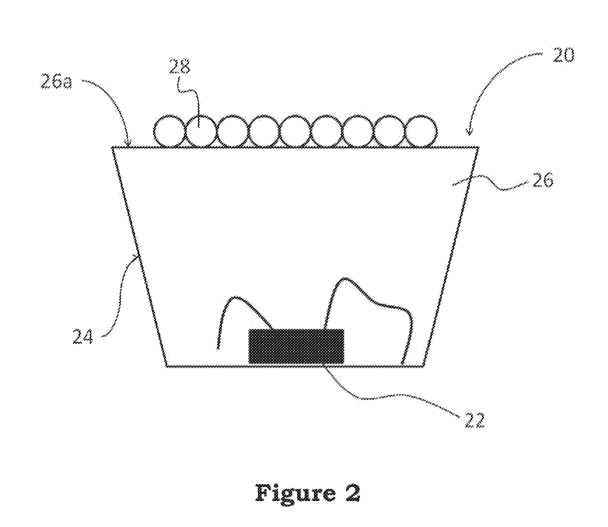

FIG. 2 is a schematic view of a white-light LED package in accordance with an embodiment of the present invention. As shown, the white-light LED package 20 includes a cup reflector 24, a LED chip 22, and a transparent encapsulated structure 26. The LED chip 22, such as a blue light LED chip, is located at a bottom of the cup reflector 24. The encapsulated structure 26 fills the inner space of the cup reflector 24 to encapsulate the LED chip 22. A predetermined portion of an outside illuminating surface 26a of the encapsulated structure 26 is covered by a first phosphor 28, which is utilized for down-converting the illumination from the LED chip 22. For example, the first phosphor 28 may be YAG: Ce³⁺ phosphor mainly for converting blue light into yellow light to generate white light illumination.

In the present embodiment of FIG. 2, the LED chip 22 is located at the center of the bottom of the cup reflector 24 and the encapsulated structure 26 has a substantially flat upper surface as the illuminating surface 26a.

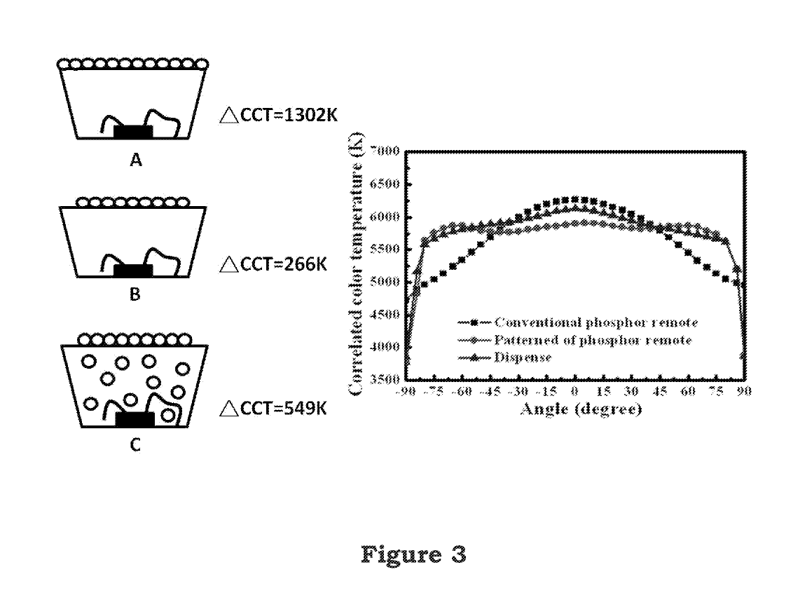

FIG. 3 is a diagram showing the experimental result of angular dependent CCT regarding the three cases: A) the typical LED package with remote phosphor; B) the LED package with patterned phosphor as described in FIG. 2; and C) the LED package with phosphor mixed in the encapsulated structure. The YAG: Ce³⁺ phosphor powders blended with silicone binder and alkyl-based solvent in the ratio 1:1:2.5 is prepared to form phosphor suspension slurry. In cases A and B, the sprinkle nozzle is used to spray out the blended phosphor on the hardened encapsulated structure by compressed air. The LED lead-frame size is 5 mm by 7 mm, and the chip size is 24 mil square with a thickness of 220 um. The blue LED chips were bonded with gold wires. The radiant fluxes of all packages with bare blue LED chips were selected to be 123 mW at 150 mA injection current to ensure the same initial condition. Instead of directly spraying phosphor-contained solvent onto the whole hardened encapsulated structure, the LED package with patterned phosphor was formed by using a circular shape mask such that only the center portion of the encapsulated structure is covered with phosphor slurry and the surrounding area was exposed.

FIG. 3 illustrating different from cases A and B, case C was formed by mixing phosphor powders into resin to form the encapsulated structure. The thickness of sprayed phosphor in cases A and B, as well as the amount of phosphor powder mixed in the resin is calibrated according to the color chromaticity coordinate based on CIT 1931 RGB color system at 150 mA injection current.

As shown in FIG. 3, CCT deviations of the LED package with the typical remote phosphor (case A) and the patterned phosphor (case B) are 1302K and 266K respectively. Regarding case A, because a light path of large angle illumination within the encapsulated structure is longer than the normal direction, the amount of blue light being absorbed by the encapsulated structure or the first phosphor particles would be higher, which may result in higher yellow light percentage near the boundary of the illuminating surface so as to show a lower CCT light around the outer perimeter of the LED package, which is called the “yellow ring”. In contrast, it is noted that in case B, the encapsulated structure is covered by one patterned phosphor, that is, the boundary of the illuminating surface of the encapsulated structure is exposed. The experimental result has indicated that the patterned phosphor has a significant improvement of angular-dependent CCT, and thus it is also believed that the patterned phosphor is also helpful for improving angular-dependent CCT and the yellow ring effect of the encapsulated structure with typical remote phosphor or phosphor mixture may be improved.

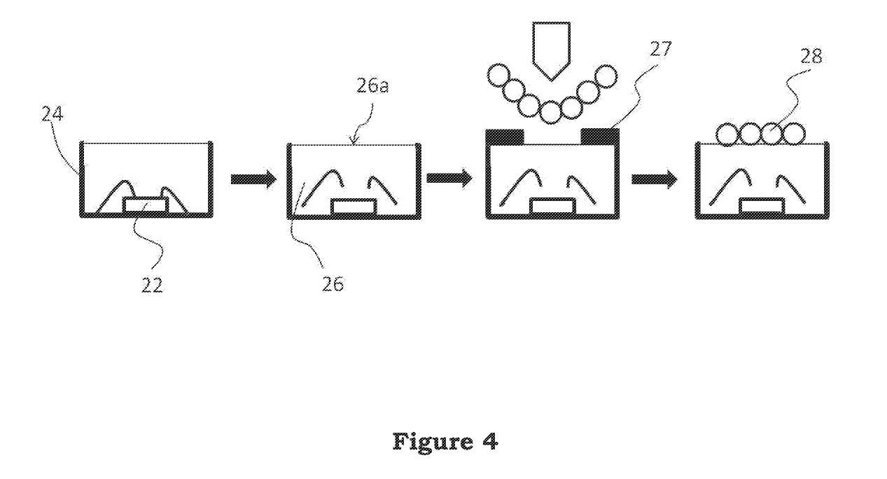

FIG. 4 shows a fabrication method of the white-light LED package of FIG. 2 in accordance with an embodiment of the present invention. Firstly, a LED chip 22 is provided and placed in a cup reflector 24. Then, a resin material is filled into the cup reflector 24 as the encapsulated structure 26 to encapsulate the LED chip 22. Thereafter, a spraying step is carried out by using a spray nozzle to spray first phosphor particles on the outside illuminating surface 26a of the hardened encapsulated structure 26 through a mask 27 so as to form a patterned first phosphor covering a predetermined region of the illuminating surface 26a for down-converting the illumination from the LED chip 22.

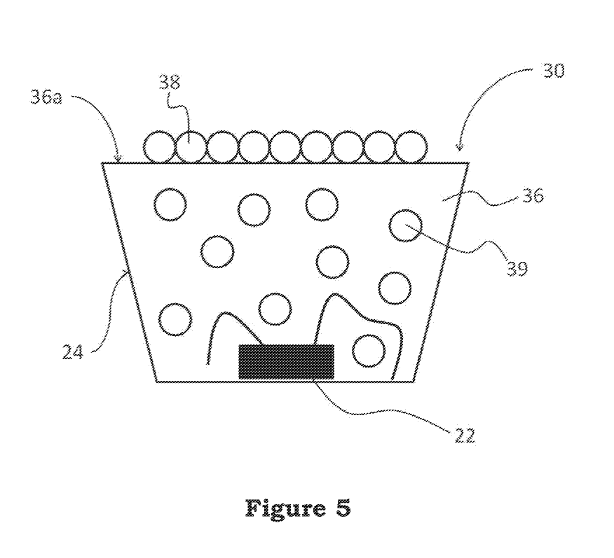

FIG. 5 is a schematic view of a white-light LED package 30 in accordance with another preferred embodiment of the present invention. In contrast with the embodiment shown in FIG. 2, the transparent encapsulated structure 36 in the present embodiment is mixed with uniformly distributed second phosphor particles 39, which is utilized for converting the illumination from the LED chip 22 into white light.

in the present. embodiment of FIG. 5, the LED chip 22 is located at the center of the bottom of the cup reflector 24 and the encapsulated structure 36 has a substantially flat upper surface as the illuminating surface 36a. Since a light path of large angle illumination within the encapsulated structure 36 is greater than the normal direction, the probability of being converted by the second phosphor particles 39 would be higher. That is, regarding the second phosphor particles 39 for converting blue light into yellow light for example, the percentage of yellow light, would be higher near the boundary of the illuminating surface 36a.

As FIG. 5, the present embodiment has a predetermined portion of the outside illuminating surface 36a, i.e. the center portion, covered by a first phosphor 28 to raise the percentage of yellow light with respect to blue light such that the angular-dependent CCT deviation can be reduced and the yellow ring effect can be minimized.

In FIG. 5, the illuminating surface 36a of the encapsulated structure 36 may be of various shapes, such as circular, square, and etc. Take the circular shape, for example, the above mentioned patterned first phosphor 38 may cover a region within a predetermined distance from a center of the circular surface.

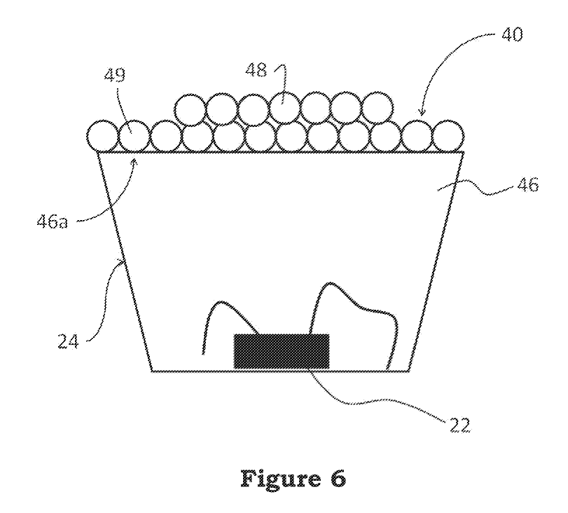

FIG. 6 is a schematic view of a white-light LED package in accordance with another preferred embodiment of the present invention. In contrast with the embodiment shown in FIG. 2, the present embodiment has a second phosphor 49 covers the whole outside illuminating surface 46a of the encapsulated structure 46 for converting the illumination from the LED chip 22 into white light.

Similar to the embodiment described in FIG. 6, the present embodiment has a predetermined portion of the outside illuminating surface 46a, i.e. the portion surrounding the center of the illuminating surface, covered by a first phosphor 48 to raise the percentage of yellow light with respect to blue light such that the angular-dependent CCT deviation can be reduced and the yellow ring effect can be minimized.

In the above mentioned embodiments from FIG. 4, FIG. 5, and FIG. 6, the encapsulated structure 26, 36, 46 shows a flat illuminating surface 26a, 36a, 46a. However, the present invention is not so restricted. The outside illuminating surface of the encapsulated structure may be a concave upper surface or have a concave region for concentrating illumination from the LED chip 22. The concave may be formed automatically by capillary phenomenon. It is noted that the concave surface may make the angular-dependent CCT of the typical LED package with remote phosphor covering the whole illuminating surface even worse.

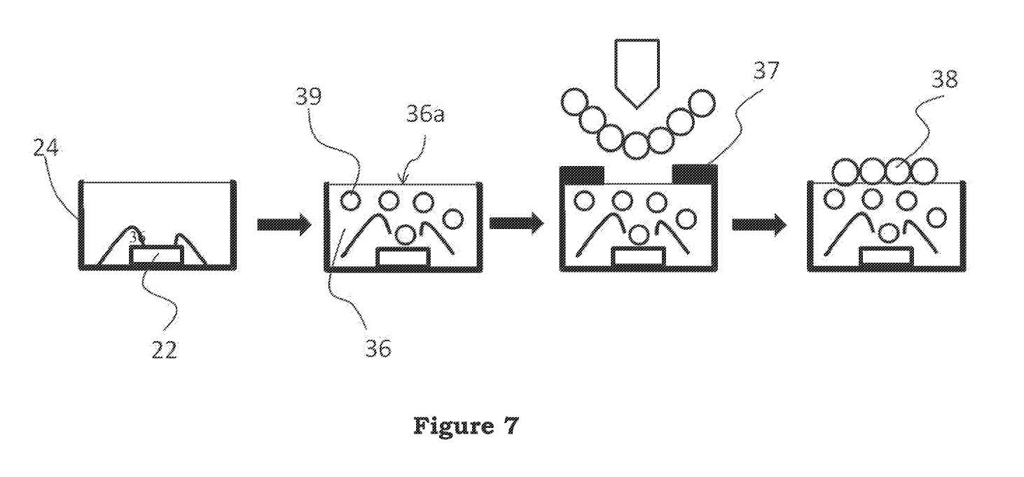

FIG. 7 shows a fabrication method of the white-light LED package of FIG. 5 in accordance with an embodiment of the present invention. Firstly, a LED chip 22 is provided and placed in a cup reflector 24. Then, a resin material is filled into the cup reflector 24 as the encapsulated structure 36 to encapsulate the LED chip 22. The resin material is mixed with second phosphor particles 39 for converting illumination from the LED chip 22 into white light. Thereafter, a spraying step is carried out to spray first phosphor particles 38 on the outside illuminating surface of the hardened encapsulated structure 36 through a mask 37 so as to form a patterned first phosphor 38 covering a predetermined region of the illuminating surface 36a for down-converting the illumination from the LED chip 22.

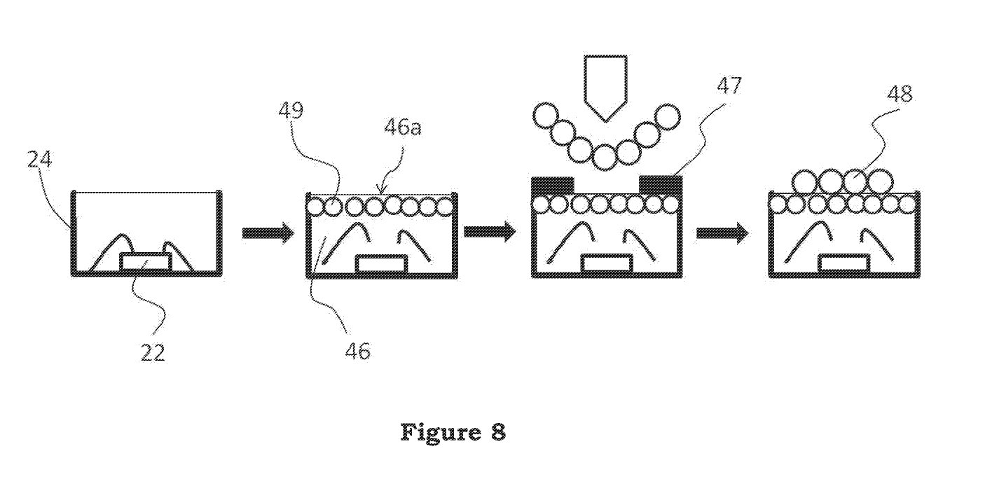

FIG. 8 shows a fabrication method of the white-light LED package of FIG. 6 in accordance an embodiment of the present invention. A major differences between the present embodiment and the embodiment of FIG. 7 is the step of distributing second phosphor particles 39,49 with respect to the illumination from the LED chip 22. In the present embodiment, the slurry with second phosphor particles 49 is deposited on the illuminating surface 46a of the encapsulated structure 46. The following spraying step is similar to the steps of FIG. 4, so that the steps are not repeated again here.

In the embodiment of FIG. 8, the first phosphor particles 48 are sprayed on the illuminating surface 46a covered with the second phosphor particles 49. However, the present invention is not so restricted; the spraying step may be carried out prior to the step of depositing the second phosphor particles 49 on the illuminating surface 46a.

The fabrication method for forming the patterned phosphor as described in the embodiments of FIGS. 4, 7 and 8 can not only be used to form a white-light LED package from the beginning but also to apply on the existed white-light LED package to improve angular-dependent CCT thereof.

The above simulations were performed on an exemplary configuration and set of dimensions, and should not be construed as limiting in any way.

It is understood that various other modifications will be apparent to and can be readily made by those skilled in the art without departing from the scope and spirit of the invention. Accordingly, it is not intended that the scope of the claims appended hereto be limited to the description as set forth herein, but rather that the claims be construed as encompassing all the features of patentable novelty that reside in the present invention, including all features that would be treated as equivalents thereof by those skilled in the art to which the invention pertains.

What is claimed is:

1. A solid state lighting luminaire, comprising:
a solid state light source;
an encapsulated structure, encapsulating the solid state light source, and having an outside illuminating surface; and
a first phosphor for down-converting the outside illumination surface from the solid state light, source being patterned to cover a portion of the outside illuminating surface.

2. The solid state lighting luminaire according to claim 1, further comprising a second phosphor distributed with respect to the whole outside illuminating surface for converting illumination from the solid state light source into white light.

3. The solid state lighting luminaire according to claim 2, wherein the second phosphor is utilized for converting blue light into yellow light.

4. The solid state lighting luminaire according to claim 2, wherein the second phosphor covers the whole outside illuminating surface.

5. The solid state lighting luminaire according to claim 2, wherein the second phosphor is mixed in the encapsulated structure.

6. The solid state lighting luminaire according to claim 1, wherein the outside illuminating surface of the encapsulated structure is a concave surface, and the patterned first phosphor covers a center region of the concave surface and leaves a boundary region of the concave surface exposed.

7. The solid state lighting luminaire according to claim 6, wherein the outside illuminating surface is a circular surface, and the patterned first phosphor covers a region within a predetermined distance from a center of the circular surface.

8. The solid state lighting luminaire according to claim 1, wherein the first phosphor is utilized for converting blue light into yellow light.

9. The solid state lighting luminaire according to claim 1, wherein the first phosphor is sprayed on the outside illuminating surface through a mask.

10. A method of fabricating a solid state lighting luminaire, comprising:
providing a solid state light source;
forming an encapsulated structure to encapsulate the solid state light source; and
spraying a patterned first phosphor that being utilized for down-converting an outside illumination surface from the solid state light source, and on a predetermined portion of the outside illuminating surface.

11. The method according to claim 10, further comprising the step of covering a whole outside illuminating surface of the encapsulated surface with a second phosphor for converting outside illumination surface from the solid state light source into white light

12. The method according to claim 10, wherein the step of spray a patterned, first phosphor, comprising:
defining a predetermined region by using a mask; and
spraying the first phosphor through the mask.

13. The method according to claim 10, wherein the first phosphor is utilized for converting blue light into yellow light.

14. The method according to claim 10, wherein the outside illuminating surface of the encapsulated structure is a concave surface, and the patterned first phosphor covers a center region of the concave surface and leaves a boundary region of the concave surface exposed.

15. The method according to claim 10, wherein the encapsulated structure is mixed with a second phosphor for converting illumination from the solid state light source into white light.
